(19) United States
(12) Patent Application Publication
(10) Pub. No.: US 2009/0276369 A1
(43) Pub. Date: Nov. 5, 2009

(54) SYSTEM AND METHOD FOR BENEFIT CONVERSION

(76) Inventors: Steven Mabry, Red Bank, NJ (US); David Kam, Port Washington, NY (US)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 12/433,416

(22) Filed: Apr. 30, 2009

Related U.S. Application Data
(60) Provisional application No. 61/050,014, filed on May 2, 2008.

(51) Int. Cl. G06Q 40/00

(52) U.S. Cl. 705/36 R; 705/35

(57) ABSTRACT

Described are systems and methods converting a first guaranteed benefit to a second guaranteed benefit. The system may include a first computing arrangement storing first annuity data indicative of a first guaranteed benefit associated with an annuity, and a second computing arrangement sending a request to the first computing arrangement to convert the first guaranteed benefit to a second guaranteed benefit. Upon receipt of the message, the first computing arrangement may store second annuity data indicative of the second guaranteed benefit associated with the annuity.

### PRIORITY CLAIM

The present application claims priority to U.S. Provisional Patent Application No. 61/050,014, entitled “SYSTEM AND METHOD FOR BENEFIT CONVERSION,” and filed on May 2, 2008, the disclosure of which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally relates to computerized systems and methods for administering annuities and other retirement investment vehicles. More specifically, an exemplary embodiment of the present invention relates to computerized systems and methods for converting a first guaranteed benefit to a second guaranteed benefit on a predetermined date after an annuity owner reaches a predetermined age.

### BACKGROUND OF THE INVENTION

A conventional guaranteed minimum income benefit (“GMIB”) may be a type of option that an annuitant can purchase as a rider to an annuity. When the annuity has been annuitized, the GMIB guarantees that the annuitant will receive a minimum payment regardless of performance of an investment underlying the annuity. That is, the GMIB provides the annuitant with a guaranteed minimum payment even when market conditions dictate that the annuity should otherwise pay less than the minimum payment.

A conventional guaranteed withdrawal benefit for life (“GWBL”) may be a type of option on a variable annuity that allows the annuitant to make withdrawals up to a maximum amount each year for the life of the annuitant. In most cases, if the amount invested is accessed, the annuity must be annuitized (which creates regular distributions), or the annuitant may incur fee penalties. The GWBL option allows access to the amount invested, regardless of the performance of the annuity, and continues to maintain and invest in the annuity.

In both cases, the annuitant needs to select the guaranteed option in advance. Since annuitants' financial conditions are likely to change over time, it would be beneficial for the annuitant to be able to put off the decision of which option to pursue and/or to change any selected option at a later date. The present invention includes computerized methods and systems for providing such benefits.

### SUMMARY OF THE INVENTION

The present invention relates to systems and methods for benefit conversion. An exemplary embodiment of the system may include a first computing arrangement storing first annuity data indicative of a first guaranteed benefit associated with an annuity, and a second computing arrangement sending a request to the first computing arrangement to convert the first guaranteed benefit to a second guaranteed benefit. Upon receipt of the message, the first computing arrangement may store second annuity data indicative of the second guaranteed benefit associated with the annuity.

The first guaranteed benefit may be a guaranteed minimum income benefit (“GMIB”) and the second guaranteed benefit may be a guaranteed withdrawal benefit for life (“GWBL”). The first computing arrangement may store data indicative of a trigger event associated with the annuity. The system may further include a timer set to a predetermined time period, and the first computing arrangement may activate the timer upon detection of the trigger event. The trigger event may include at least one of a user reaching a predetermined age, a predetermined anniversary of issuance of the annuity, a failure to exercise the first guaranteed benefit, a deferral of a payment from the annuity, a value of an investment underlying the annuity reaching a predetermined threshold and a market index reaching a predetermined value. The predetermined time period may be thirty days.

The first computing arrangement may include at least one of a server and a database. The second computing arrangement may include at least one of a personal computer and a handheld device.

An exemplary embodiment of the method according to the present invention may include the steps of: generating an annuity contract having a first guaranteed benefit rider, converting the first guaranteed benefit rider to a second guaranteed benefit rider on a predetermined date after an owner of the annuity contract reaches a predetermined age, and computing payments to be made to the owner at predetermined intervals according to terms in the second guaranteed benefit rider.

The generating step may include receiving a request including user data and annuity data, and identifying terms for the annuity contract based on the user data and the annuity data. The converting step may include detecting a trigger event associated with the annuity contract. Upon detecting the trigger event, the terms of the second guaranteed benefit rider may be associated with the annuity contract.

A time period may be set during which the first guaranteed benefit rider can be converted to the second guaranteed benefit rider A request may be received that requests at least one of (i) to exercise the first guaranteed benefit rider, (ii) to allow the first guaranteed benefit rider to lapse and deactivate the second guaranteed benefit rider, and (iii) to elect to convert the first guaranteed benefit rider to the second guaranteed benefit rider.

The computing step may include determining an initial contribution to the annuity contract, computing a percentage of the initial contribution based on at least one of (i) a type of the annuity contract and (ii) a value of an investment made with the initial contribution, and computing the payment as a function of the initial contribution and the percentage.

The payments may be transmitted to the owner according to a predetermined schedule, and/or the owner may be allowed to withdraw an amount up to a value of the payment. Each withdrawal may be monitored and a cumulative withdrawal amount for a predetermined time period may be computed. If the cumulative withdrawal amount exceeds a predetermined threshold amount, the payment may be recalculated.

### BRIEF DESCRIPTION OF THE DRAWINGS

Further objects, features and advantages of the invention will become apparent from the following detailed description taken in conjunction with the accompanying drawings showing illustrative embodiments of the invention, in which:

FIG. 1 is a system for conversion of guaranteed benefits according to an embodiment of the present invention; and

FIG. 2 is a method for conversion of guaranteed benefits according to an embodiment of the present invention.

### DETAILED DESCRIPTION OF THE INVENTION

In the following description of embodiments of the invention, reference is made to the accompanying drawings that form a part hereof and in which is shown by way of illustration a number of exemplary embodiments in which the invention may be practiced. It is to be understood that other embodiments may be utilized and structural changes may be made without departing from the scope of the present invention.

In an exemplary embodiment of the present invention, an annuity includes a first guaranteed benefit which can be converted to a second guaranteed benefit through, for example, action or inaction by an owner of the annuity. The conversion may occur due to, for example, at least one (or a predetermined combination) of an express request by the annuity owner, the annuity owner reaching a predetermined age, the annuity reaching a predetermined anniversary date, the annuity owner exercising the first guaranteed benefit, the annuity owner annuitizing the annuity, the investment(s) underlying the annuity reaching a predetermined value, a market index reaching a predetermined value and/or any other trigger event or time.

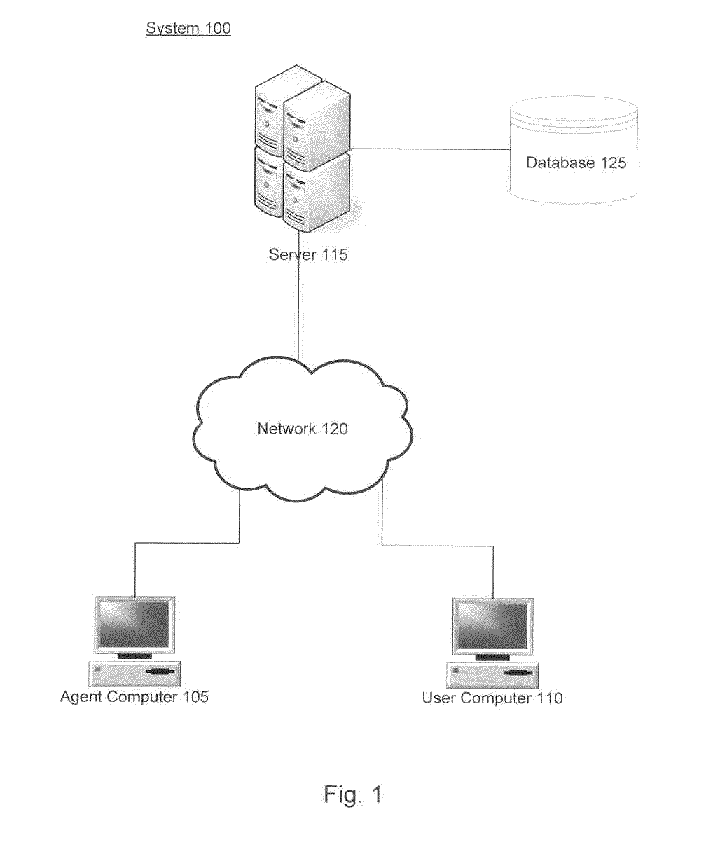

FIG. 1 shows an exemplary embodiment of a system 100 for benefit conversion according to the present invention. The system 100 may include one or more computing arrangements such as, for example, an agent computer 105, a user computer 110 and a server 115 that may be communicatively coupled to a network 120, which may include one or more wired and/or wireless local and wide area networks, such as the Internet. The server 115 may include and/or be coupled to one or more storage devices and/or components (e.g., a database 125) which store data and files. Those of skill in the art will understand that the system 100 may include any number of computers, servers and/or databases and may include other devices with access to the network 120.

The agent computer 105 and/or the user computer 110 may be personal computers or handheld devices which include a processor, transient and persistent storage devices, input/output subsystem and a bus to provide a communications path therebetween. The server 115 may be, for example, a database server, an application server, a web server and an FTP server, or any combination thereof. Those of skill in the art will understand that the computers, server and/or database (and/or any of the functions thereof) may be implemented in any combination of hardware and/or software.

In an exemplary embodiment, a user may request, e.g., using the user computer 110, information (e.g., a quote) for an annuity (or other retirement and/or insurance product). In other embodiments, the request may be made via a phone call (e.g., using an automated voice prompt system) or by mail (e.g., filling out and mailing a scannable form). The request may be sent over the network 120 to the agent computer 105 and/or the server 115. For example, if the request is initially received by the server 115 (e.g., if entered over a web interface/form displayed on the user computer 100), the server 115 may select an appropriate agent to receive the request (e.g., a given agent responds to a given request type, using a request queuing system, a token, a round-robin distribution scheme, etc.) and transmit the request to the agent computer 105. As understood by those of skill in the art, the agent computer 105 may receive a notification (e.g., email, instant message) that the request has been received and the agent may access a remote system (e.g., hosted by the server 115) through a network interface (e.g., a website). The agent may then use a software application (e.g., on the agent computer 105 or the server 115) to generate a quote for an annuity in response to the request. That is, the request may include user data indicative of, for example, the user's gender, age, location, medical history, employment history, etc. and/or annuity data indicative of features, benefits, expectations, costs, single/joint life, etc. that the user would like the annuity to provide. In other exemplary embodiments, a software application may automatically generate a quote and/or draft annuity contract based on the user data and/or the annuity data, which the agent may review (e.g., the request and the generated quote and/or annuity contract may be provided to the agent simultaneously).

In an exemplary embodiment of the present invention, the annuity data in the request may include a request for a conversion feature. For example, the conversion feature may be a first guaranteed benefit which can be converted to a second guaranteed benefit upon occurrence of a trigger event. In one exemplary embodiment, the first guaranteed benefit may be a guaranteed minimum income benefit (“GMIB”) and the second guaranteed benefit may be a guaranteed withdrawal benefit for life (“GWBL”). Those of skill in the art will understand that the terms “first” and “second” are merely meant to differentiate between the guaranteed benefits and not meant to limit the first guaranteed benefit to the GMIB or the second guaranteed benefit to the GWBL, i.e., the first (or second) guaranteed benefit can be the GMIB or the GWBL. The trigger event may be, for example, any one or more of the user reaching a predetermined age, a predetermined anniversary of issuance of the annuity, inaction by the user (e.g., failure to exercise an option/benefit), exercise of an option/benefit, deferral of payments, a value of an investment(s) underlying the annuity reaching a predetermined value, a market index reaching a predetermined value, etc. In an exemplary embodiment, the GMIB may converted to the GWBL when the user reaches age 85, if the GMIB has not been exercised. As understood by those of skill in the art, if the user purchases the annuity, all data associated with the annuity (e.g., contributions, investments, features, riders, conversions, trigger events, charges, etc.) and the user (e.g., name, address, age, gender, medical history, employment history, etc.) may be stored in the server 115 and/or the database 125.

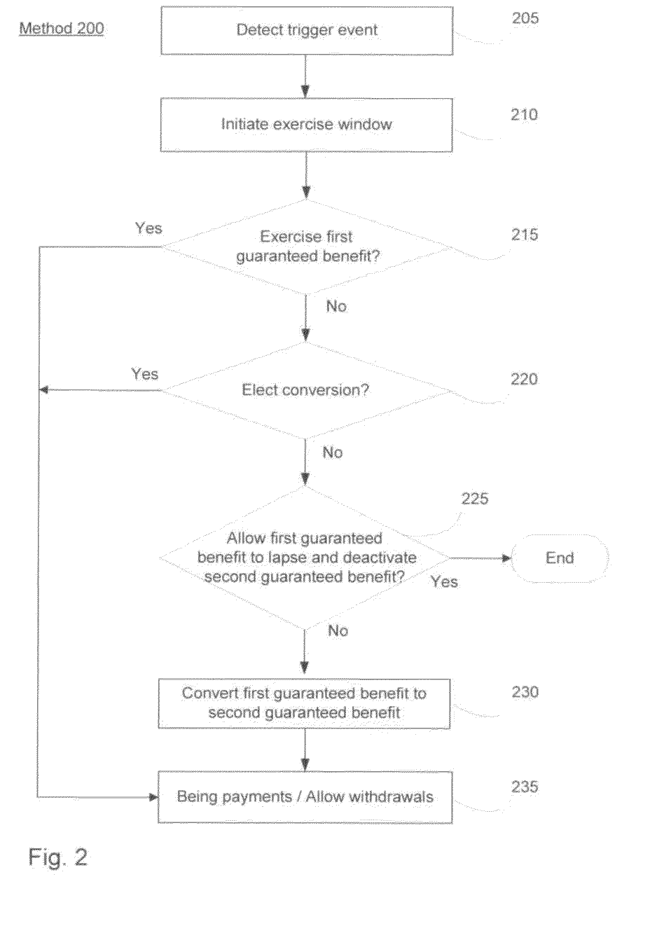

FIG. 2 illustrates an exemplary embodiment of a method 200 for conversion of guaranteed benefits according to the present invention. In exemplary method 200, the user has purchased an annuity (or a rider thereto) which includes the conversion feature. In other embodiments, the conversion feature may be included on all annuity products, e.g., as a standard feature which is not purchased separately.

In step 205, a trigger event associated with the conversion feature is detected. In an exemplary embodiment, the trigger event may be the anniversary date of issuance of the annuity following the user's 85^{th} birthday. As noted above, various other trigger events may be utilized. The trigger event may be detected by the server 115. For example, when the annuity is purchased, the server 115 may store data associated with the trigger event (e.g., the user's date of birth and annuity issuance date) and update the data, as necessary (e.g., count the years until the user reaches a predetermined age). When the trigger event is detected, the server 115 may send a message to the agent computer 105 and/or the user computer 110 indicating that the trigger event has occurred.

In step 210, an exercise window is initiated. The exercise window may be a predetermined time period (e.g., 30 days) in which the user may exercise the first guaranteed benefit, e.g., the GMIB. In an exemplary embodiment, when the server 115 detects the trigger event, it may set and activate a timer for the predetermined time period. The server 115 may send messages to the agent computer 105 and/or the user computer 110 to indicate lapsing of intervals of the timer (e.g., every 5 days, every 5 days until the last 5 days then daily).

In step 215, it is determined whether the first guaranteed benefit is exercised. For example, in one exemplary embodiment, the user may decide to exercise the first guaranteed benefit (e.g., the GMIB) and begin to receive payments (step 235), e.g., according to a predetermined schedule (e.g., monthly). The messages sent to the agent computer 105 and/or the user computer 110 to indicate that the exercise window has been initiated (and any follow-up messages sent, e.g., as reminders, thereafter) may include a series of options, one of which may be a confirmation request regarding exercise of the first guaranteed benefit. To exercise the first guaranteed benefit, the user may enter data (e.g., check a box on a web form, send an email, etc.) on the user computer 110, confirming that the user desires to exercise the first guaranteed benefit or call the agent who may enter similar data on the agent computer 105. The server 115 may receive the data from the user computer 110 and/or the agent computer 105 and confirm that the first guaranteed benefit has been exercised. In one exemplary embodiment, if the user exercises the first guaranteed benefit, the conversion feature may be terminated. In other exemplary embodiments, the user may be presented with an option to exercise the conversion feature for every trigger event that is detected (e.g., on each annuity issuance anniversary).

In step 220, it is determined whether there has been an election to convert the first guaranteed benefit to the second guaranteed benefit. For example, in one exemplary embodiment, the user may elect to convert the first guaranteed benefit (e.g., the GMIB) to the second guaranteed benefit (e.g., the GWBL) and begin to have the GAWA available for withdrawal (step 235). The messages sent to the agent computer 105 and/or the user computer 110 to indicate that the exercise window has been initiated (and any follow-up messages sent, e.g., as reminders, thereafter) may include a series of options, one of which may be an option to elect to convert the first guaranteed benefit to the second guaranteed benefit. To elect the conversion, the user may enter data (e.g., check a box on a web form, send an email, etc.) on the user computer 110, confirming that the user desires to elect the conversion or call the agent who may enter similar data on the agent computer 105. The server 115 may receive the data from the user computer 110 and/or the agent computer 105 and confirm that the first guaranteed benefit has been converted to the second guaranteed benefit. In one exemplary embodiment, the conversion may be irrevocable (i.e., the first guaranteed benefit may no longer be available to the user under the annuity). However, in other exemplary embodiments, the user may be presented with an option to revoke the election for every trigger event that is detected (e.g., on each annuity issuance anniversary).

In step 225, it is determined whether there has been confirmation that the conversion will not be elected. In another exemplary embodiment, it may also be determined whether there has been confirmation that the first guaranteed benefit will not be exercised. For example, in one exemplary embodiment, the user may confirm that the first guaranteed benefit (e.g., the GMIB) will not be converted into the second guaranteed benefit (e.g., the GWBL) and that the first guaranteed benefit will not be exercised. The messages sent to the agent computer 105 and/or the user computer 110 to indicate that the exercise window has been initiated (and any follow-up messages sent, e.g., as reminders, thereafter) may include a series of options, one of which may be an option to confirm that the first guaranteed benefit will not be converted to the second guaranteed benefit and that the first guaranteed benefit will not be exercised. To select this option, the user may enter data (e.g., check a box on a web form, send an email, etc.) on the user computer 110, confirming that the user desires to select this option or call the agent who may enter similar data on the agent computer 105. The server 115 may receive the data from the user computer 110 and/or the agent computer 105 and confirm that the option has been selected.

In step 230, the first guaranteed benefit is converted into the second guaranteed benefit, e.g., because the predetermined time period associated with the exercise window expired. In an exemplary embodiment, step 230 may be provided as a default option, e.g., the conversion may be automatically executed if the user does not provide any instruction otherwise during the exercise window. In an exemplary embodiment, the conversion may be retroactive to the date of the trigger event.

As understood by those of skill in the art, in steps 220 and 230, when the first guaranteed benefit is converted to the second guaranteed benefit, the server 115 may record the conversion by, for example, associating conversion data with the data regarding the annuity and the user. The conversion data may include, but is not limited to, an identifier indicative of the trigger event, a date of the trigger event, a date of the conversion, and a method of the election of the conversion (e.g., by election, by default). Upon the conversion, the server 115 may calculate a new payment amount available to the user. For example, in an embodiment in which the GMIB is converted to the GWBL, the server 115 may calculate the GAWA that is available to the user and may report the GAWA to the agent and/or user by sending a message indicative of the GAWA to the agent computer 105 and/or the user computer 110.

In step 235, payments from the first or second guaranteed benefits may begin. For example, in one exemplary embodiment, if the user exercises the GMIB, payments may be made at predetermined intervals; if the user elects the conversion, the GAWA may be made available for withdrawal.

In an exemplary embodiment, the default conversion may be a single life annuity regardless of whether the original annuity was a joint life annuity.

The GAWA may be calculated based on an amount contributed to or invested in the annuity. For example, a “benefit base” may refer to an amount contributed to the annuity while an “account value” may refer to a value of the annuity (e.g., based on performance of the investment(s) underlying the annuity). The benefit base may be increased by contributions, rollovers, and/or annual ratchets (e.g., on a predetermined date, the benefit base may be reset to the greater of a current account value and a prior benefit base). As known to those of skill in the art, the benefit base for the GMIB may be rolled up and the rolled up benefit base may be reset annually to equal the account value on each contract anniversary. An increase in the benefit base may result in an increase in the fee charged for providing the GWBL.

In one exemplary embodiment, the GAWA may be the benefit base multiplied by a predetermined percentage. The benefit base may be the rolled up benefit base of the GMIB. For example, if the benefit base equals the account value, the p redetermined percentage may be in a first range (e.g., 7.0-7.5%), and if the benefit base equals a GMIB benefit base, the predetermined percentage may be in a second range (e.g., 6.0-6.5%).

### EXAMPLES

(assuming single life annuity, 6% GMIB elected, and GMIB is not exercised within 30 days after the contract date anniversary following age 85 resulting in the default conversion; AP=applicable percentage)

### Example 1

The GAWA is the Greater of:

| A | | B |
|---|---|---|
| GMIB benefit base × AP = | OR | Account Value × AP = |
| GAWA | | GAWA |
| $200,000 × 6% = $12,000 | | $100,000 × 7% = $7,000 |

Since A produced the higher GAWA,
The GWBL Benefit Base is $200,000 (which was the GMIB Benefit Base)
Applicable Percentage = 6%
GAWA = $12,000 (start anytime)
Note:
If first withdrawal is taken at age 88 it means they lose the GAWA they could have taken at ages 85-87.
If Account Value increases to $300,000 and GWBL Benefit Base ratchets, then the GAWA will become $21,000 for life ($300,000 × 7%)

### Example 2

The GAWA is the Greater of:

| A | | B |
|---|---|---|
| GMIB benefit base × AP = | OR | Account Value × AP = |
| GAWA | | GAWA |
| $115,000 × 6% = $6,900 | | $100,000 × 7% = $7,000 |

Since B produced the higher GAWA,
The GWBL Benefit Base is $100,000 (which was the Account Value as of the contract anniv following age 85)
Applicable Percentage = 7%
GAWA = $7,000 (start anytime)
Note:
If first withdrawal is taken at age 88 it means they lose the GAWA they could have taken at ages 85-87.
If Account Value decreases to $50,000, GAWA remains at $7,000 regardless of when payments begin.
If Account Value increases to $200,000 and GWBL Benefit Base ratchets, then the GAWA will become $14,000 for life ($200,000 × 7%)

### Example 3

The GAWA is the Greater of:

| A | | B |
|---|---|---|
| GMIB benefit base × AP = | OR | Account Value × AP = |
| GAWA | | GAWA |
| $100,000 | | $200,000 × 7% = $14,000 |
| $200,000 × 6% = $12,000 | | |

GMIB Benefit Base on the contract anniversary following age 85 will ratchet to Account Value if Account Value is higher. This will be the last GMIB Benefit Base annual ratchet. Any fee increase that would have been applicable on that contract anniversary as a result of a GMIB Benefit Base reset will not be applicable with this last ratchet.
Since B produced the higher GAWA:
The GWBL Benefit Base is $200,000 (which was the Account Value as of the contract anniv following age 85)
Applicable Percentage = 7%
GAWA = $14,000 (start anytime)
Note:
If first withdrawal is taken at age 88 it means they lose the GAWA they could have taken at ages 85-87.
If Account Value decreases to $50,000, GAWA remains at $14,000 regardless of when payments begin.
If Account Value increases to $300,000 and GWBL Benefit Base ratchets, then the GAWA will become $21,000 for life ($300,000 × 7%).

Prior to a first withdrawal after the first guaranteed benefit is converted to the second guaranteed benefit, the user may elect a joint life. As described above with respect to other exemplary embodiments, to elect joint life, the user may enter data (e.g., check a box on a web form, send an email, etc.) on the user computer 110, confirming that the user desires to select this option or call the agent who may enter similar data on the agent computer 105. The server 115 may receive the data from the user computer 110 and/or the agent computer 105 and confirm that the option has been selected. If the joint life is elected and the user's spouse/partner is older than a predetermined age (e.g., 85 years old), the applicable percentage (“AP”) may be reduced by a predetermined increment, e.g., 0.5%. The chart below shows an exemplary embodiment of the effect of an election of joint life may have on the AP:

| | 6.5% GMIB Elected | | 6% GMIB Elected | |
|---|---|---|---|---|
| | A | B | A | B |
| | AP* if AAV | AP if GMIB | AP if AAV | AP if GMIB |
| | produces a | BB produces | produces a | BB produces |
| | higher | a higher | higher | a higher |
| | GAWA | GAWA | GAWA | GAWA |
| Single Life | 7.5% | 6.5% | 7.0% | 6.0% |
| (All ages) | | | | |
| Joint Life if | | | | |
| spouse is: | | | | |
| Age 85+ | 7.0% | 5.5% | 6.5% | 5.0% |
| Ages 80-84 | 6.5% | 5.0% | 6.0% | 4.5% |
| Ages 75-79 | 6.0% | 4.5% | 5.5% | 4.0% |
| Ages 70-74 | 5.5% | 4.0% | 5.0% | 3.5% |
| Ages 65-69 | 5.0% | 3.5% | 4.5% | 3.0% |

Withdrawals from the annuity may be made on a scheduled or ad-hoc basis. The schedule for withdrawals may be the result of a user decision. For example, in one exemplary embodiment, upon conversion of the GMIB to the GWBL, the server 115 may request the user to provide (or select from several options) a schedule for withdrawals or confirm that ad-hoc withdrawals will be taken. The server 115 may also notify the user of the GAWA and provide notifications of a cumulative withdrawal amount each time a withdrawal is made.

In an exemplary embodiment, when the GMIB is converted into the GWBL, an “excess withdrawal” may occur if cumulative withdrawals within a predetermined time period (e.g., a contract year) are greater than the GAWA. If an excess withdrawal occurs, the benefit base may be reset to the lesser of the benefit base immediately prior to the excess withdrawal and the account value immediately following the excess withdrawal. The GAWA may then be recalculated based on the reset benefit base. In this exemplary embodiment, for example, the server 115 may record withdrawals made by the user and detect when an excess withdrawal occurs. Upon detection of an excess withdrawal, the server 115 may send a notification message to the agent computer 105 and/or the user computer 110 identifying the excess withdrawal and the consequences of such a withdrawal. The server 115 may also recalculate the benefit base and the GAWA and associate those values with the annuity (e.g., in the database 125).

Upon death of the user, in a single-life embodiment, a death benefit may be paid and the annuity may be terminated. For example, data may be entered (e.g., through the agent computer 105) indicating that the user is deceased, and the server 115 may send a message instructing the death benefit to be paid and close (and/or archive in the database 125) a file associated with the annuity. In a joint-life embodiment, upon the death of the user, the spouse/partner may continue to have the GAWA available for withdrawal. For example, data may be entered (e.g., through the agent computer 105) indicating that the user is deceased, and the server 115 may write data to indicate that the spouse/partner is entitled to the GWBL. The server 115 may track the withdrawals made by the spouse/partner to determine whether an excess withdrawal occurs.

The figures are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or any other similar memory device. Computer programs (also called computer control logic or computer readable program code) are stored in a main and/or secondary memory, and executed by one or more processors (controllers, or the like) to cause the one or more processors to perform the functions of the invention as described herein.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computerized system, comprising:
a first computing arrangement storing first annuity data indicative of a first guaranteed benefit associated with an annuity; and
a second computing arrangement sending a request to the first computing arrangement to convert the first guaranteed benefit to a second guaranteed benefit,
wherein, upon receipt of the message, the first computing arrangement stores second annuity data indicative of the second guaranteed benefit associated with the annuity.

2. The system according to claim 1, wherein the first guaranteed benefit is a guaranteed minimum income benefit (“GMIB”).

3. The system according to claim 2, wherein the second guaranteed benefit is a guaranteed withdrawal benefit for life (“GWBL”).

4. The system according to claim 1, wherein the first computing arrangement stores data indicative of a trigger event associated with the annuity.

5. The system according to claim 4, further comprising:
a timer set to a predetermined time period,
wherein the first computing arrangement activates the timer upon detection of the trigger event.

6. The system according to claim 4, wherein the trigger event includes at least one of a user reaching a predetermined age, a predetermined anniversary of issuance of the annuity, a failure to exercise the first guaranteed benefit, a deferral of a payment from the annuity, a value of an investment underlying the annuity reaching a predetermined threshold and a market index reaching a predetermined value.

7. The system according to claim 5, wherein the predetermined time period is thirty days.

8. The system according to claim 1, wherein the first computing arrangement includes at least one of a server and a database.

9. The system according to claim 1, wherein the second computing arrangement includes at least one of a personal computer and a handheld device.

10. A method, comprising:
generating an annuity contract having a first guaranteed benefit rider;
converting the first guaranteed benefit rider to a second guaranteed benefit rider on a predetermined date after an owner of the annuity contract reaches a predetermined age; and
computing payments to be made to the owner at predetermined intervals according to terms in the second guaranteed benefit rider.

11. The method according to claim 10, wherein the generating includes:
receiving a request including user data and annuity data; and
identifying terms for the annuity contract based on the user data and the annuity data.

12. The method according to claim 10, wherein the converting includes:
detecting a trigger event associated with the annuity contract.

13. The method according to claim 12, further comprising:
upon detecting the trigger event, associating the terms of the second guaranteed benefit rider with the annuity contract.

14. The method according to claim 13, further comprising:
setting a time period during which the first guaranteed benefit rider can be converted to the second guaranteed benefit rider

15. The method according to claim 14, further comprising:
receiving a request to at least one of (i) exercise the first guaranteed benefit rider, (ii) allow the first guaranteed benefit rider to lapse and deactivate the second guaranteed benefit rider, and (iii) elect to convert the first guaranteed benefit rider to the second guaranteed benefit rider.

16. The method according to claim 10, wherein the computing includes:
determining an initial contribution to the annuity contract;
computing a percentage of the initial contribution based on at least one of (i) a type of the annuity contract and (ii) a value of an investment made with the initial contribution; and
computing the payment as a function of the initial contribution and the percentage.

17. The method according to claim 10, further comprising:
transmitting the payments to the owner according to a predetermined schedule.

18. The method according to claim 10, further comprising:
allowing the owner to withdraw an amount up to a value of the payment.

19. The method according to claim 18, further comprising:
monitoring each withdrawal; and
computing a cumulative withdrawal amount for a predetermined time period.

20. The method according to claim 19, further comprising:
re-computing the payment when the cumulative withdrawal amount exceeds a predetermined threshold amount.
